(19) United States
(12) Patent Application Publication
(10) Pub. No.: US 2024/0244509 A1
(43) Pub. Date: Jul. 18, 2024

(54) METHOD AND APPARATUS FOR SYSTEM INFORMATION ACQUISITION

(71) Applicant: Lenovo (Beijing) Limited, Beijing (CN)

(72) Inventors: Lianhai Wu, Beijing (CN); Prateek Basu Mallick, Dreieich (DE); Joachim Löhr, Wiesbaden (DE)

(73) Assignee: Lenovo (Beijing) Limited, Beijing (CN)

(21) Appl. No.: 18/289,598

(22) PCT Filed: May 10, 2021
(86) PCT No.: PCT/CN2021/092856

§ 371 Date: Nov. 6, 2023

(51) Int. Cl. H04W 48/14; H04W 88/04

(52) U.S. Cl. CPC H04W 48/14; H04W 88/04

(57) ABSTRACT

Embodiments of the present disclosure relate to methods and apparatuses for system information acquisition. According to some embodiments of the disclosure, a method may include: receiving a request for a system information block (SIB) from a user equipment (UE), wherein the UE accesses a cell via the relay node: transmitting the requested SIB to the UE: receiving an updated version of the requested SIB from the cell: and transmitting the updated version of the requested SIB to the UE via a sidelink communication.

### TECHNICAL FIELD

Embodiments of the present disclosure generally relate to wireless communication technology, especially to system information acquisition in a wireless communication system.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a SL, rather than being linked through the BS. A relaying function based on a sidelink may be supported in a communication network. For example, a UE supporting sidelink communication may function as a relay node to extend the coverage of a BS. An out-of-coverage UE may communicate with a BS (e.g., a cell of the BS) via a relay node (e.g., a relay UE). In the context of the present disclosure, a relay node, which functions as a relay between a UE (remote UE) and a BS, may be referred to a UE-to-network relay or a U2N relay.

There is a need for efficiently performing communication in a communication system supporting a U2N relay.

### SUMMARY

Some embodiments of the present disclosure provide a method performed by a relay node. According to some embodiments of the present disclosure, the method may include: receiving a request for a system information block (SIB) from a user equipment (UE), wherein the UE accesses a cell via the relay node; transmitting the requested SIB to the UE; receiving an updated version of the requested SIB from the cell; and transmitting the updated version of the requested SIB to the UE.

Some embodiments of the present disclosure provide a method performed by a user equipment (UE). According to some embodiments of the present disclosure, the method may include: transmitting a request for a system information block (SIB) to a relay node, wherein the UE accesses a cell via the relay node; receiving the requested SIB from the relay node; and receiving an updated version of the requested SIB from the relay node.

According to some embodiments of the present disclosure, the method may further include transmitting, to the relay node, an indicator indicating that the requested SIB is not needed at the UE.

According to some embodiments of the present disclosure, the method may further include receiving a SIB list indicating that the requested SIB is updated from the relay node. The method may further include transmitting a request for the updated version of the requested SIB to the relay node.

According to some embodiments of the present disclosure, the method may further include transmitting an acknowledgement to the relay node in response to receiving the requested SIB.

According to some embodiments of the present disclosure, the method may further include at least one of the following: starting a validity timer for the requested SIB in response to receiving the requested SIB or the updated version of the requested SIB; and transmitting a request for the requested SIB to the relay node in response to the expiry of the validly timer.

According to some embodiments of the present disclosure, the method may further include receiving a radio resource control (RRC) reconfiguration message from the cell via the relay node, wherein the RRC reconfiguration message may include an information element (IE) indicating whether the UE is allowed to request a SIB via the relay node or not. In response to the UE being out of the coverage area of the cell and the IE indicating that the UE is allowed to request a SIB, the UE may be allowed to request a SIB via the relay node. In response to the UE being within the coverage area of the cell and the IE indicating that the UE is allowed to request a SIB, the UE may not be allowed to request a SIB via the relay node and may be allowed to request a SIB via a Uu link.

According to some embodiments of the present disclosure, the request for the SIB may be transmitted via a radio resource control (RRC) reconfiguration sidelink message, which may include a SIB request list indicating the requested SIB. According to some embodiments of the present disclosure, the request for the SIB may be transmitted via a PC5 RRC message specified for SIB request.

According to some embodiments of the present disclosure, the method may further include starting a SIB request prohibit timer for the requested SIB in response to transmitting the request for the SIB. The method may further include prohibiting transmitting another request for the requested SIB when the SIB request prohibit timer is running. The method may further include transmitting a request for the requested SIB when the SIB request prohibit timer is running and the content of the requested SIB is changed.

According to some embodiments of the present disclosure, the method may further include: switching from the relay node to another relay node; and transmitting a system information area ID and a value tag of a SIB of interest to the another relay node. In some examples, the method may further include receiving, from the another relay node, an indicator indicating that the SIB of interest is valid. In some examples, the method may further include receiving, from the another relay node, a current version of the SIB of interest, and a system information area ID and a value tag of the current version of the SIB of interest. The method may further include starting a validity timer for the SIB of interest in response to receiving the indicator or the current version of the SIB of interest.

According to some embodiments of the present disclosure, the method may further include: switching from the relay node to another relay node; receiving a system information area ID and a value tag of a first SIB from the another relay node; and determining whether to update the first SIB based on the received system information area ID and value tag. The method may further include: transmitting a list of SIBs of interest including the first SIB to the another relay node in response to determining to update the first SIB; receiving an updated version of the first SIB from the another relay node; and starting a validity timer for the first SIB in response to receiving the updated version of the first SIB.

Some embodiments of the present disclosure provide a relay node. According to some embodiments of the present disclosure, the relay node may include: a processor; and a transceiver coupled to the processor, wherein the transceiver is configured to: receive a request for a system information block (SIB) from a user equipment (UE), wherein the UE accesses a cell via the relay node; transmit the requested SIB to the UE; receive an updated version of the requested SIB from the cell; and transmit the updated version of the requested SIB to the UE.

According to some embodiments of the present disclosure, the processor may be configured to maintain an association between the UE and a SIB list, wherein the SIB list contains the requested SIB.

The transceiver may be further configured to receive, from the UE, an indicator indicating that the requested SIB is not needed at the UE. The processor may be further configured to remove the requested SIB from the SIB list in response to receiving the indicator.

The transceiver may be further configured to receive, from the cell, a SIB based on the SIB list in response to the SIB being updated by the cell. To transmit the updated version of the requested SIB to the UE, the transceiver may be configured to transmit the updated version of the requested SIB based on the association.

According to some embodiments of the present disclosure, the transceiver may be further configured to: transmit a SIB list indicating that the requested SIB is updated to the UE in response to receiving the updated version of the requested SIB from the cell. The transceiver may be further configured to receive a request for the updated version of the requested SIB from the UE. To transmit the updated version of the requested SIB to the UE, the transceiver may be configured to transmit the updated version of the requested SIB to the UE in response to receiving the request for the updated version of the requested SIB.

According to some embodiments of the present disclosure, the processor may be configured to determine whether the requested SIB is stored at the relay node or not in response to receiving the request for the SIB from the UE. The transceiver may be further configured to transmit the request for the SIB to the cell and receive the requested SIB from the cell in response to the requested SIB being not stored at the relay node.

According to some embodiments of the present disclosure, the processor may be configured to determine whether the requested SIB is stored at the relay node or not in response to receiving the request for the SIB from the UE. To transmit the requested SIB to the UE, the transceiver may be configured to transmit the stored requested SIB to the UE in response to the requested SIB being stored at the relay node.

According to some embodiments of the present disclosure, the processor may be configured to store the requested SIB at the relay node after transmitting the requested SIB to the UE. According to some embodiments of the present disclosure, the transceiver may be further configured to receive an acknowledgement of the reception of the requested SIB from the UE, and the processor may be configured to discard the requested SIB in response to receiving the acknowledgement and receiving no additional request for the requested SIB. According to some embodiments of the present disclosure, the transceiver may be further configured to receive an acknowledgement of the reception of the requested SIB from the UE, and the processor may be configured to start a timer in response to receiving the acknowledgement and discard the requested SIB in response to the expiry of the timer. The processor may be further configured to stop the timer in response to receiving another request for the requested SIB from the UE or another UE. The transceiver may be further configured to transmit the requested SIB to the UE or another UE in response to the another request.

According to some embodiments of the present disclosure, the request for the SIB may be received via a radio resource control (RRC) reconfiguration sidelink message, which includes a SIB request list indicating the requested SIB. According to some embodiments of the present disclosure, the request for the SIB may be received via a PC5 RRC message specified for SIB request.

According to some embodiments of the present disclosure, the processor may be configured to start a timer in response to transmitting the requested SIB to the UE. The transceiver may be further configured to receive an acknowledgement of the reception of the requested SIB from the UE. The processor may be configured to stop the timer in response to receiving the acknowledgement. The transceiver may be further configured to retransmit the requested SIB to the UE in response to the expiry of the timer or receive a negative acknowledgement of the reception of the requested SIB from the UE.

Some embodiments of the present disclosure provide a user equipment (UE). According to some embodiments of the present disclosure, the UE may include: a processor; and a transceiver coupled to the processor, wherein the transceiver is configured to: transmit a request for a system information block (SIB) to a relay node, wherein the UE accesses a cell via the relay node; receive the requested SIB from the relay node; and receive an updated version of the requested SIB from the relay node.

According to some embodiments of the present disclosure, the transceiver may be further configured to transmit, to the relay node, an indicator indicating that the requested SIB is not needed at the UE.

According to some embodiments of the present disclosure, the transceiver may be further configured to receive a SIB list indicating that the requested SIB is updated from the relay node. The transceiver may be further configured to transmit a request for the updated version of the requested SIB to the relay node.

According to some embodiments of the present disclosure, the transceiver may be further configured to transmit an acknowledgement to the relay node in response to receiving the requested SIB.

According to some embodiments of the present disclosure, the processor may be configured to start a validity timer for the requested SIB in response to receiving the requested SIB or the updated version of the requested SIB. The transceiver may be further configured to transmit a request for the requested SIB to the relay node in response to the expiry of the validly timer.

According to some embodiments of the present disclosure, the transceiver may be further configured to: receive a radio resource control (RRC) reconfiguration message from the cell via the relay node, wherein the RRC reconfiguration message includes an information element (IE) indicating whether the UE is allowed to request a SIB via the relay node or not. In response to the UE being out of the coverage area of the cell and the IE indicating that the UE is allowed to request a SIB, the UE may be allowed to request a SIB via the relay node. In response to the UE being within the coverage area of the cell and the IE indicating that the UE is allowed to request a SIB, the UE may not be allowed to request a SIB via the relay node and may be allowed to request a SIB via a Uu link.

According to some embodiments of the present disclosure, the request for the SIB may be transmitted via a radio resource control (RRC) reconfiguration sidelink message, which includes a SIB request list indicating the requested SIB. According to some embodiments of the present disclosure, the request for the SIB may be transmitted via a PC5 RRC message specified for SIB request.

According to some embodiments of the present disclosure, the processor may be configured to start a SIB request prohibit timer for the requested SIB in response to transmitting the request for the SIB. According to some embodiments of the present disclosure, the processor may be further configured to prohibit transmitting another request for the requested SIB when the SIB request prohibit timer is running. According to some embodiments of the present disclosure, the transceiver may be further configured to transmit a request for the requested SIB when the SIB request prohibit timer is running and the content of the requested SIB is changed.

According to some embodiments of the present disclosure, the processor may be configured to switch the UE from the relay node to another relay node. The transceiver may be further configured to transmit a system information area ID and a value tag of a SIB of interest to the another relay node. In some examples, the transceiver may be further configured to: receive, from the another relay node, an indicator indicating that the SIB of interest is valid. In some examples, the transceiver may be further configured to: receive, from the another relay node, a current version of the SIB of interest, and a system information area ID and a value tag of the current version of the SIB of interest. The processor may be further configured to start a validity timer for the SIB of interest in response to receiving the indicator or the current version of the SIB of interest.

According to some embodiments of the present disclosure, the processor may be configured to switch the UE from the relay node to another relay node. The transceiver may be further configured to receive a system information area ID and a value tag of a first SIB from the another relay node. The processor may be further configured to determine whether to update the first SIB based on the received system information area ID and value tag. The transceiver may be further configured to: transmit a list of SIBs of interest including the first SIB to the another relay node in response to determining to update the first SIB; and receive an updated version of the first SIB from the another relay node. The processor may be further configured to start a validity timer for the first SIB in response to receiving the updated version of the first SIB.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate the communications among a remote UE, a U2N relay, and a BS and can facilitate and improve the implementation of various communication technologies, such as 5G NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure;

FIG. 2 illustrates an exemplary flowchart of a sidelink RRC reconfiguration procedure in accordance with some embodiments of the present disclosure;

FIG. 3 illustrates a schematic diagram of a wireless communication system in accordance with some embodiments of the present disclosure;

FIG. 4 illustrates an exemplary procedure for wireless communications in accordance with some embodiments of the present disclosure;

FIG. 5 illustrates an exemplary procedure for wireless communications in accordance with some embodiments of the present disclosure;

FIG. 6 illustrates an exemplary procedure for wireless communications in accordance with some embodiments of the present disclosure;

FIG. 7 illustrates an exemplary procedure for wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

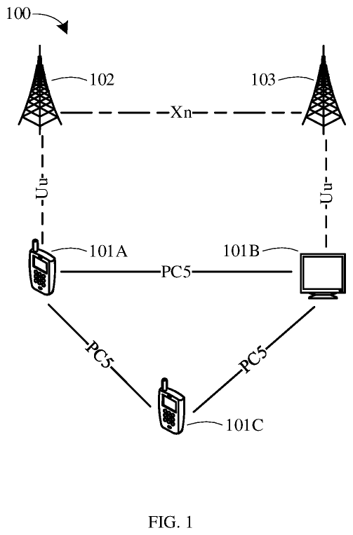

FIG. 1 illustrates a schematic diagram of a wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X Sidelink communication.

NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, the wireless communication system 100 may include some base stations (e.g., BS 102 and BS 103) and some UEs (e.g., UE 101A, UE 101B, and UE 101C). Although a specific number of UEs and BSs is depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, the BS 102 and the BS 103 may be included in a next generation radio access network (NG-RAN). In some embodiments of the present disclosure, the BS 102 may be a gNB and the BS 103 may be an ng-eNB.

The UE 101A and UE 101B may be in-coverage (e.g., inside the NG-RAN). For example, as shown in FIG. 1, the UE 101A may be within the coverage of BS 102, and the UE 101B may be within the coverage of BS 103. The UE 101C may be out-of-coverage (e.g., outside the coverage of the NG-RAN). For example, as shown in FIG. 1, the UE 101C may be outside the coverage of any BSs, for example, both the BS 102 and BS 103. The UE 101A and UE 101B may respectively connect to the BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. In some embodiments of the present disclosure, a UE-to-network relay is supported. For example, an in-coverage UE in communication with an out-of-coverage UE may function as a relay node between the serving BS of the in-coverage UE and the out-of-coverage UE.

Although UEs are exemplified as the U2N relays in the above and the following embodiments, it should be appreciated by persons skilled in the art that other devices that can connect to the BS and support sidelink communications or the like can also function as U2N relays.

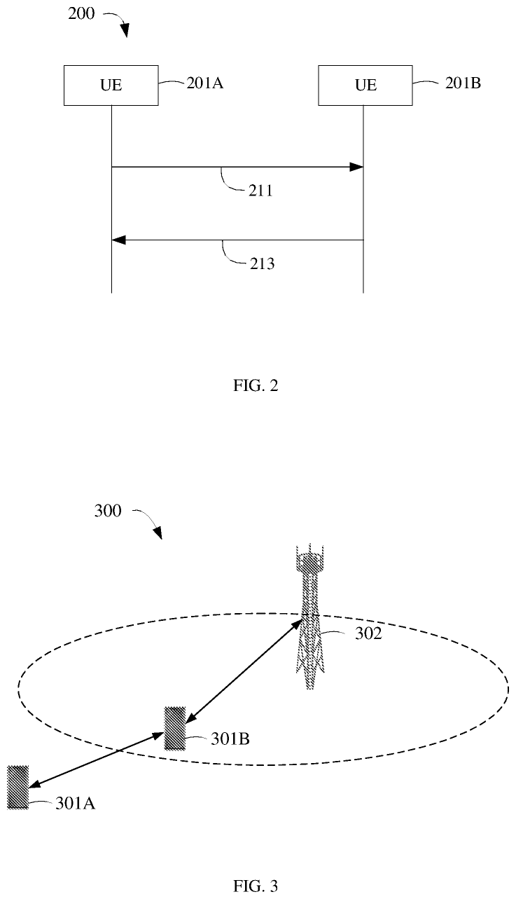

FIG. 2 illustrates an exemplary flowchart of a sidelink RRC reconfiguration procedure 200 in accordance with some embodiments of the present disclosure.

The purpose of the sidelink RRC reconfiguration procedure is to modify a PC5-RRC connection. In some examples, a UE may perform such procedure to establish, modify, or release a sidelink data radio bearer (DRB). In some examples, a UE may perform such procedure to configure an NR sidelink measurement and reporting. In some examples, a UE may perform such procedure to configure sidelink channel state information (CSI) reference signal resources.

Referring to FIG. 2, UE 201A may initiate a sidelink RRC reconfiguration procedure, and may transmit an RRC reconfiguration sidelink message to a peer UE (e.g., UE 201B) in operation 211. A peer UE of the UE 201A refers to a UE that is or will be in sidelink communication with UE 201A. In response to the transmission of the RRC reconfiguration sidelink message, UE 201A may start a sidelink reconfiguration timer (e.g., T400 as specified in 3GPP specifications).

After receiving the RRC reconfiguration sidelink message, UE 201B may perform corresponding operations, for example, releasing or establishing sidelink DRBs between UE 201A and UE 201B. In the case that UE 201B has successfully performed the operations, UE 201B may transmit an RRC reconfiguration complete sidelink message to UE 201A in operation 213. Otherwise, in the case that UE 201B has failed to perform the operations, UE 201B may transmit an RRC reconfiguration failure sidelink message to UE 201A in operation 213. In response to receiving the RRC reconfiguration complete sidelink message or RRC reconfiguration failure sidelink message, UE 201A may stop the sidelink reconfiguration timer. In response to the expiry of the sidelink reconfiguration timer or the reception of the RRC reconfiguration failure sidelink message, UE 201A may consider that a failure has occurred on the radio link.

FIG. 3 illustrates a schematic diagram of a wireless communication system 300 in accordance with some embodiments of the present disclosure.

As shown in FIG. 3, the wireless communication system 300 may include a BS (e.g., BS 302) and some UEs (e.g., UE 301A and UE 301B). Although a specific number of UEs and BS is depicted in FIG. 3, it is contemplated that any number of UEs may be included in the wireless communication system 300.

Referring to FIG. 3, UE 301B may be within the coverage of BS 302. UE 301B and BS 302 may establish an RRC connection therebetween. UE 301A may be outside of the coverage of BS 302. In some examples, UE 301B may function as UE 101A or UE 101B shown in FIG. 1, and UE 301A may function as UE 101C shown in FIG. 1.

The wireless communication system 300 may support sidelink communications. For example, UE 301B may be in sidelink communication with UE 301A. A PC5 RRC connection may be established between UE 301A and UE 301B. In some embodiments of the present disclosure, UE 301A may initiate a procedure for establishing connection with BS 302 via UE 301B (i.e., UE-to-network relay). For example, UE 301A may transmit an RRC setup request to BS 302 via UE 301B. BS 302 may transmit an RRC setup message including a response to UE 301A via UE 301B. After such procedure, UE 301A may access BS 302 (e.g., a cell of BS 302) via UE 301B. This cell is referred to as the serving cell of UE 301A. UE 301A and BS 302 may establish an RRC connection therebetween, and UE 301A may have RRC states, such as an RRC_IDLE state, an RRC_INACTIVE state, and an RRC_CONNECTED state. UE 301A may also be referred to as a remote UE and UE 301B may also be referred to as a relay node, a relay UE, or a serving relay of UE 301A.

It should be appreciated by persons skilled in the art that although a single relay node between UE 301A and BS 302 is depicted in FIG. 3, it is contemplated that any number of relay nodes may be included.

In a wireless communication system, a BS may transmit (e.g., broadcast) system information (SI) over the air interface. A communication device (e.g., UE 301B in FIG. 3) within the coverage of the BS may receive the SI. The SI may include a master information block (MIB) and a number of system information blocks (SIBs), which are divided into minimum SI and other SI.

Minimum SI may include basic information required for initial access and information for acquiring any other SI. For example, minimum SI may include an MIB, which may include cell barred status information and essential physical layer information of the cell required to receive further system information, e.g., CORESET #0 configuration. The MIB may be periodically broadcast on a broadcast channel (BCH). Minimum SI may also include SIB1, which may define the scheduling of other system information blocks and contain information required for initial access. SIB1 may also be referred to as remaining minimum SI (RMSI) and may be periodically broadcast on a downlink shared channel (DL-SCH) or transmitted in a dedicated manner on a DL-SCH to UEs in the RRC_CONNECTED state.

Other SI may include all SIBs not broadcast in the minimum SI. These SIBs can either be periodically broadcast on a DL-SCH, broadcast on-demand on a DL-SCH (e.g., in response to a request from a UE in the RRC_IDLE, RRC_INACTIVE, or RRC_CONNECTED state), or transmitted in a dedicated manner on a DL-SCH to UEs in the RRC_CONNECTED state (e.g., in response to a request, if configured by the network, from a UE in the RRC_CONNECTED state or when the UE has an active BWP with no common search space configured). For example, other SI may include, but is not limited to, at least one of the following:
SIB2, which may include cell re-selection information, mainly related to the serving cell;
SIB3, which may include information about the serving frequency and intra-frequency neighboring cells relevant for cell re-selection (including cell re-selection parameters common for a frequency as well as cell specific re-selection parameters);
SIB4, which may include information about other NR frequencies and inter-frequency neighboring cells relevant for cell re-selection (including cell re-selection parameters common for a frequency as well as cell specific re-selection parameters), which can also be used for NR idle/inactive measurements;
SIB5, which may include information about E-UTRA frequencies and E-UTRA neighboring cells relevant for cell re-selection (including cell re-selection parameters common for a frequency as well as cell specific re-selection parameters);
SIB6, which may include an earthquake and tsunami warning system (ETWS) primary notification;
SIB7, which may include an ETWS secondary notification;
SIB8, which may include a commercial mobile alert service (CMAS) warning notification;
SIB9, which may include information related to global position system (GPS) time and coordinated universal time (UTC);
SIB10, which may include the human-readable network names (HRNN) of the non-public networks (NPNs) listed in SIB1;
SIB11, which may include information related to idle/inactive measurements; and
SIBpos, which may include positioning assistance data as defined in 3GPP specifications such as TS 37.355 and TS 38.331.

For sidelink communications, other SI may further include, but is not limited to, at least one of the following:
SIB12, which may include information related to NR sidelink communication;
SIB13, which may include information related to SystemInformationBlockType21 for V2X sidelink communication as specified in 3GPP specifications such as TS 36.331 clause 5.2.2.28; and
SIB14, which may include information related to SystemInformationBlockType26 for V2X sidelink communication as specified in 3GPP specifications such as TS 36.331 clause 5.2.2.33.

For UEs (e.g., UE 301B in FIG. 3) in the RRC_CONNECTED states, a request for other SI may be transmitted to the network, if configured by the network, in a dedicated manner (e.g., via an uplink dedicated control channel (UL-DCCH)). The granularity of the request may be one SIB. The BS (e.g., the serving cell) may respond with an RRC reconfiguration message including the requested SIB(s). In some embodiments, it is the network's choice to decide which requested SIBs are delivered in a dedicated or broadcasted manner.

The other SI may be broadcast at a configurable periodicity and for a certain duration. The other SI may also be broadcast when it is requested by a UE in the RRC_IDLE, RRC_INACTIVE, or RRC_CONNECTED state.

Change of system information (other than for ETWS/CMAS) may only occur at specific radio frames. For example, the concept of a modification period may be employed. System information may be transmitted a number of times with the same content within a modification period, as defined by its scheduling. The modification period may be configured by the system information.

When the network changes some or all of the system information, it may first notify the UEs about this change, which may be done, for example, throughout a modification period. In the next modification period, the network may transmit the updated system information. In response to receiving a change notification, a UE may acquire the new system information from the start of the next modification period. The UE may apply the previously acquired system information until the UE acquires the new system information.

A remote UE may not be able to directly acquire the SI from a BS, for example, when the remote UE is out of the coverage area of the BS. Embodiments of the present disclosure provide solutions to facilitate the system information acquisition.

For example, in some embodiments of the present disclosure, a relay node (e.g., UE 301B as shown in FIG. 3, which may function as a relay node between BS 302 and UE 301A) can forward the system information to a remote UE (e.g., UE 301A in FIG. 3) via broadcast, groupcast, or dedicated PC5-RRC signaling. In some embodiments of the present disclosure, a remote UE in the RRC_IDLE, RRC_INACTIVE, or RRC_CONNECTED state may support an on-demand SI request.

In some embodiments of the present disclosure, a PC5-RRC message can be used to carry the system information forwarding via the PC5 link. A dedicated SIB request procedure may be employed for the remote UE in the RRC_CONNECTED state to request SI via a relay node.

More details on the embodiments of the present disclosure will be illustrated in the following text in combination with the appended drawings.

Although the above issues and the below solutions are described with respect to a specific network architecture or application scenario (e.g., a relay UE), it should be appreciated by persons skilled in the art that the above issues may exist in other specific network architectures or application scenarios (e.g., a stationary relay), and the solutions can still solve the above issues.

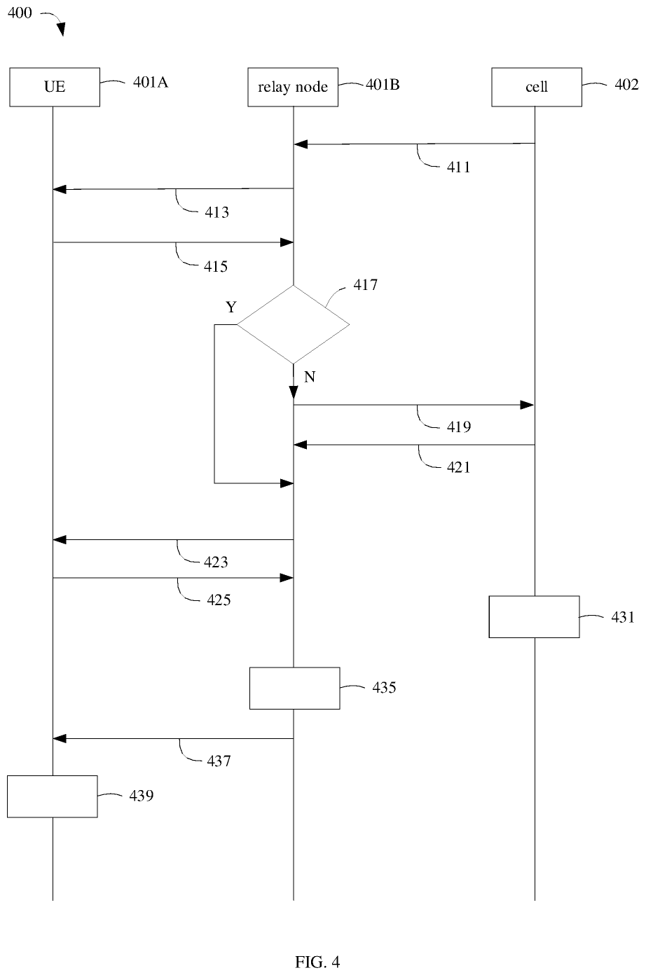

FIG. 4 illustrates an exemplary procedure 400 for wireless communications in accordance with some embodiments of the present disclosure. Details described in all of the foregoing embodiments of the present disclosure are applicable for the embodiments shown in FIG. 4.

Referring to FIG. 4, relay node 401B may be connected to a BS (e.g., a cell 402 of the BS) and may function as a relay node between BS 402 and UE 401A. That is, UE 401A may access the BS (e.g., cell 402) via relay node 401B. For example, the BS may function as BS 102 or BS 103 shown in FIG. 1, or BS 302 shown in FIG. 3. Relay node 401B may function as UE 101A or UE 101B shown in FIG. 1, or UE 301B shown in FIG. 3. UE 401A may function as UE 101C shown in FIG. 1 or UE 301A shown in FIG. 3.

In some embodiments of the present disclosure, cell 402 may transmit an RRC reconfiguration message to UE 401A via relay node 401B. For example, in operation 411, cell 402 may transmit an RRC reconfiguration message destined for UE 401A to relay node 401B, which may then forward the RRC reconfiguration message to UE 401A in operation 413.

In some embodiments of the present disclosure, relay node 401B may receive and store the system information, which may include, for example, SIB1, SIB2, . . . , and SIB15.

UE 401A may determine whether it is allowed to request a SIB via the relay node. For example, UE 401A may make the determination based on the received RRC reconfiguration message. Details of how to indicate whether a remote UE is allowed to request a SIB via a relay node will be described in the following text. When UE 401A is allowed to request a SIB via the relay node, UE 401A may transmit a request for a SIB(s) to relay node 401B in operation 415. In some embodiments of the present disclosure, the SIB request may include a list indicating the requested SIB(s).

In some embodiments of the present disclosure, relay node 401B may maintain (e.g., store and update) an association between a remote UE (e.g., UE 401A) and a SIB type list. The SIB type list may indicate the SIB(s) requested by the remote UE, which suggests that the remote UE is interested in such SIB(s). For example, the association may map the ID of UE 401A to a SIB type list. In response to receiving the SIB request from UE 401A, relay node 401B may add the requested SIB(s) indicated by the SIB request to the SIB type list associated with UE 401A (or ID of UE 401A).

In some embodiments of the present disclosure, if UE 401A is not interested in a certain SIB, UE 401A may inform relay node 401B that UE 401A does not need the SIB anymore. In response to receiving such indication, relay node 401B may remove the indicated SIB from the SIB type list associated with UE 401A.

In response to receiving the SIB request, relay node 401B may determine whether the requested SIB(s) is stored at relay node 401B in operation 417. If it is determined that the requested SIB(s) is stored at relay node 401B, relay node 401B may, in operation 423, transmit the requested SIB(s) to UE 401A directly without requesting from cell 402.

If it is determined that the requested SIB(s) is not stored at relay node 401B, relay node 401B may receive the requested SIB(s) from the serving cell. For example, in operation 419, relay node 401B may transmit a request for the requested SIB(s) to cell 402. In operation 421, cell 402 may transmit the requested SIB(s) to relay node 401B. In operation 423, relay node 401B may transmit the requested SIB(s) to UE 401A.

UE 401A may assume that the version of an available SIB is valid. For example, in some embodiments of the present disclosure, UE 401A may consider the received SIB(s) as valid, and may start (or restart) a validity timer for the received SIB(s) in response to receiving the SIB(s). The value of the timer may be, for example, configurable or predefined in 3GPP specifications. In an example, the value of the timer may be predefined as 3 hours. UE 401A may transmit a request for the received SIB to relay node 401B in response to the expiry of the validity timer.

In some embodiments of the present disclosure, after relay node 401B receives the SIB request for a certain SIB(s) (e.g., the SIB request from UE 401A), relay node 401B may continue to store the SIB(s) received from cell 402 in case that another remote UE (not shown in FIG. 4) may request the same SIB(s).

In some embodiments of the present disclosure, relay node 401B may discard the received SIB(s). In some examples, in response to receiving the requested SIB(s), UE 401A may transmit a response to relay node 401B in operation 425. The response may be an acknowledgement from, for example, the RRC layer, MAC layer or adaptation layer.

Relay node 401B may discard the requested SIB(s) in response to receiving the acknowledgement and receiving no additional request for the requested SIB(s) (e.g., no other UE is requesting the same SIB(s)).

In some examples, relay node 401B may discard the received SIB(s) in response to the acknowledgement from UE 401A and no additional request for the same SIB(s) in a time duration. For example, in response to receiving the acknowledgement of the reception of the requested SIB(s) from UE 401A, relay node 401B may start a timer. In response to the expiry of the timer, relay node 401B may discard the requested SIB(s). Relay node 401B may stop the timer in response to receiving another request for the requested SIB(s) from UE 401A or another UE (not shown in FIG. 4). Relay node 401B may transmit the requested SIB(s) to UE 401A or the another UE.

In some circumstances, cell 402 may update certain SIBs in operation 431. Relay node 401B may need to receive the SIB(s) of interest to itself as well as the serving remote UE(s) (e.g., UE 401A). For example, in operation 435, relay node 401B may receive the SIB(s) based on its own service and requirement. In some embodiments of the present disclosure, relay node 401B may receive the SIB(s) based on the requested SIB list(s) received from the serving remote UE(s). For example, relay node 401B may receive the SIB(s) indicated in the SIB type list(s) associated with the serving remote UE(s).

In some embodiments of the present disclosure, in response to receiving the updated version of a certain SIB(s), relay node 401B may transmit the updated SIB(s) to a corresponding remote UE based on the association between the remote UE and the corresponding SIB type list. For example, when relay node 401B determines that an updated SIB is indicated the SIB type list associated with UE 401A, relay node 401B may transmit the updated SIB to UE 401A in operation 437.

In some embodiments of the present disclosure, relay node 401B may not maintain the association between a remote UE and the corresponding SIB type list. In response to receiving the updated version of a certain SIB(s), relay node 401B may inform the serving remote UE(s) which SIB has been updated. A remote UE may respond to relay node 401B whether the remote UE needs the updated SIB(s).

For example, relay node 401B may transmit a SIB list indicating the updated SIB(s) (e.g., SIB type(s) of the updated SIB(s)) to UE 401A in operation 437. In operation 439, UE 401A may determine whether to update the current SIB(s) based on the SIB list. For example, UE 401A may transmit a SIB request for the updated version of a certain SIB(s). In response to receiving the SIB request, relay node 401B may transmit the updated version of the requested SIB(s) to UE 401A.

UE 401A may assume that the version of an available SIB is valid. For example, in some embodiments of the present disclosure, UE 401A may consider the received updated version of the SIB(s) as valid, and may start (or restart) a validity timer for the SIB(s) in response to receiving the updated version of the SIB(s).

It should be appreciated by persons skilled in the art that the sequence of the operations in exemplary procedure 400 may be changed and some of the operations in exemplary procedure 400 may be eliminated or modified, without departing from the spirit and scope of the disclosure.

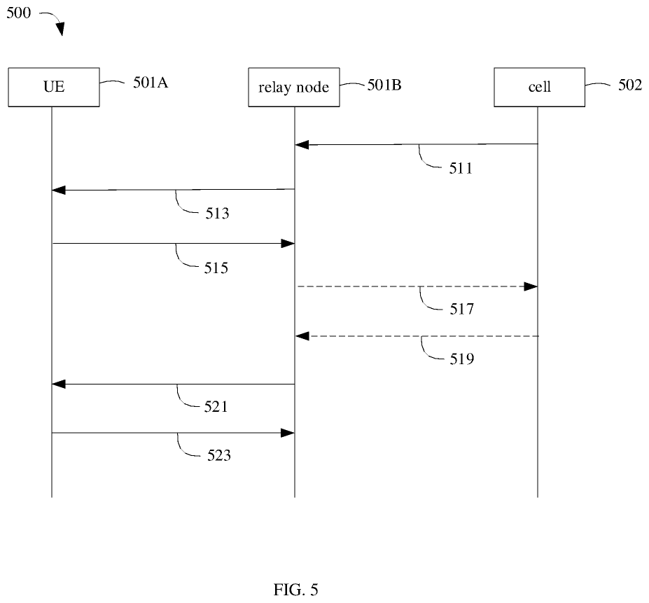

FIG. 5 illustrates an exemplary procedure 500 for wireless communications in accordance with some embodiments of the present disclosure. Details described in all of the foregoing embodiments of the present disclosure are applicable for the embodiments shown in FIG. 5.

Referring to FIG. 5, relay node 501B may be connected to a BS (e.g., cell 502 of the BS) and may function as a relay node between BS 502 and UE 501A. That is, UE 501A may access the BS (e.g., cell 502) via relay node 501B. For example, the BS may function as BS 102 or BS 103 shown in FIG. 1, or BS 302 shown in FIG. 3. Relay node 501B may function as UE 101A or UE 101B shown in FIG. 1, or UE 301B shown in FIG. 3. UE 501A may function as UE 101C shown in FIG. 1 or UE 301A shown in FIG. 3.

In some embodiments of the present disclosure, cell 502 may transmit an RRC reconfiguration message to UE 501A via relay node 501B. For example, in operation 511, cell 502 may transmit an RRC reconfiguration message destined for UE 501A to relay node 501B, which may then forward the RRC reconfiguration message to UE 501A in operation 513.

UE 501A may determine whether it is allowed to request a SIB via a relay node (e.g., relay node 501B). In some embodiments of the present disclosure, the received RRC reconfiguration message may include an information element (IE) indicating whether a remote UE is allowed to request a SIB via a relay node or not.

In some embodiments, an IE in the RRC reconfiguration message may be specified to indicate whether a remote UE is allowed to request a SIB via a relay node.

In some other embodiments, the IE (e.g., “onDemandSIB-Request IE” as specified in the 3GPP specification) which is used to indicate whether a UE is allowed to request a SIB from a BS or a cell or not may be reused or extended to indicate whether a remote UE is allowed to request a SIB via a relay node or not.

For instance, the value of onDemandSIB-Request IE may be set as “setup” to indicate that a UE is allowed to request a SIB or “release” to indicate that a UE is not allowed to request a SIB. In some examples, UE 501A may be out of the coverage area of cell 502. When UE 501A receives the onDemandSIB-Request IE with “setup,” UE 501A may determine that it is allowed to request a SIB on-demand via relay node 501B. In some examples, UE 501A may be within the coverage area of cell 502. When UE 501A receives the onDemandSIB-Request IE with “setup,” UE 501A may determine that it is not allowed to request a SIB on-demand via relay node 501B, and is allowed to request a SIB on-demand via the Uu link (since UE 501A is within the coverage area of cell 502).

When UE 501A is allowed to request a SIB via a relay node, UE 501A may transmit a request for a SIB(s) to relay node 501B in operation 515.

In some embodiments, the request for a SIB(s) may be transmitted via an RRC reconfiguration sidelink message. The RRC reconfiguration sidelink message may include a SIB request list indicating the requested SIB(s). For example, a SIB-RequestList IE may be added in the RRC reconfiguration sidelink message for SIB request transmission.

The sidelink reconfiguration timer (e.g., T400 as specified in 3GPP specifications) may be reused to control the SIB request transmission on the PC5 link. For example, in response to transmitting the RRC reconfiguration sidelink message including the SIB request list, UE 501A may start the sidelink reconfiguration timer. When the sidelink reconfiguration timer is running, UE 501A may be prohibited from transmitting another request for the requested SIB(s). However, when the content of the requested SIB(s) is changed, UE 501A may be allowed to transmit a request for requested SIB(s) even when the sidelink reconfiguration timer is running.

In some embodiments, the request for a SIB(s) may be transmitted via a PC5 RRC message (e.g., a SIB Request message) specified for SIB request transmission. This message may include a SIB request list indicating the requested SIB(s). For example, a SIB-RequestList IE may be added in the message.

A timer (hereinafter, “SIB request prohibit timer”) may be employed to control the SIB request transmission on the PC5 link. For example, in response to transmitting the SIB Request message, UE 501A may start the SIB request prohibit timer. When the SIB request prohibit timer is running. UE 501A may be prohibited from transmitting another request for the requested SIB(s). However, when the content of the requested SIB(s) is changed, UE 501A may be allowed to transmit a request for requested SIB(s) even when the SIB request prohibit timer is running.

In some embodiments of the present disclosure, in response to receiving the SIB request from UE 501A, relay node 501B may receive the request SIB(s) from cell 502. For example, in operation 517 (denoted by the dotted arrow as an option), relay node 501B may transmit a request for the requested SIB(s) to cell 502. In operation 519 (denoted by the dotted arrow as an option), cell 502 may transmit the requested SIB(s) to relay node 501B. In operation 521, relay node 501B may transmit the requested SIB(s) to UE 501A. In some embodiments of the present disclosure, when the requested SIB(s) is stored at relay node 501B, relay node 501B may, in operation 521, transmit the stored requested SIB(s) to UE 501A directly without requesting from cell 502.

In some examples, in response to receiving the requested SIB(s), UE 501A may transmit a response (e.g., via RRC signaling) to relay node 501B in operation 523. In some embodiments of the present disclosure, when relay node 501B does not receive the response from UE 501A, relay node 501B may retransmit the requested SIB(s). Certain mechanisms may be employed to control the retransmission procedure.

For example, relay node 501B may start a timer in response to transmitting the requested SIB(s) to UE 501A. In response to receiving an acknowledgement of the reception of the requested SIB(s) from UE 501A, relay node 501B may stop the timer.

In response to the expiry of the timer or receiving a negative acknowledgement of the reception of the requested SIB(s) from UE 501A, relay node 501B may retransmit the requested SIB(s) to UE 501A.

It should be appreciated by persons skilled in the art that the sequence of the operations in exemplary procedure 500 may be changed and some of the operations in exemplary procedure 500 may be eliminated or modified, without departing from the spirit and scope of the disclosure.

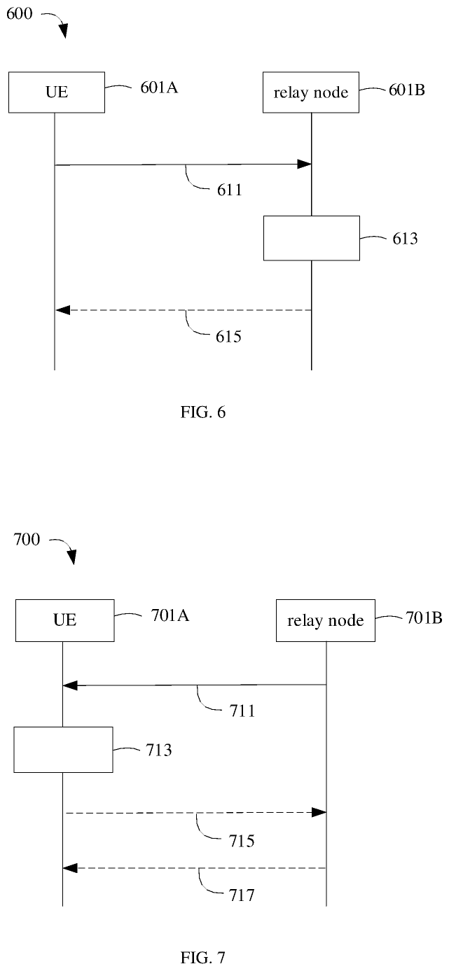

FIG. 6 illustrates an exemplary procedure 600 for wireless communications in accordance with some embodiments of the present disclosure. Details described in all of the foregoing embodiments of the present disclosure are applicable for the embodiments shown in FIG. 6.

Referring to FIG. 6, before switching to relay node 601B, UE 601A may access a cell (not shown in FIG. 6) via another relay node (source relay node, not shown in FIG. 6) and receive the SIB(s) from the source relay node, or UE 601A may access the cell via a Uu link. In some examples, relay node 601B may function as UE 101A or UE 101B shown in FIG. 1, or UE 301B shown in FIG. 3. UE 601A may function as UE 101C shown in FIG. 1 or UE 301A shown in FIG. 3.

Due to some reasons, UE 601A may switch from the source relay node or the serving cell to relay node 601B. After switching to relay node 601B, UE 601A may need to determine the validity of the system information applied at UE 601A and updated the invalid system information accordingly.

In some embodiments of the present disclosure, in operation 611, UE 601A may transmit information associated with certain system information applied at UE 601A to relay node 601B. For example, UE 601A may transmit a system information area ID and a value tag of a SIB (also referred to as “SIB of interest”) to relay node 601B. The specific definitions of the system information area ID and the value tag of a SIB are specified in 3GPP specification.

In operation 613, relay node 601B may determine whether the received system information area ID and value tag of the SIB of interest are identical to those of the same SIB being, for example, broadcast in the serving cell of relay node 601B. When the system information area IDs and value tags are the same, relay node 601B may transmit an optional confirmation to UE 601A. For example, relay node 601B may transmit an indicator indicating that the SIB of interest is valid to UE 601A. In another example, if UE 601A does not receive any response, UE 601A may assume that the SIB of interest is valid.

Otherwise, if either the system information area IDs or the value tags are different, relay node 601B may transmit a current version of the SIB of interest, and the system information area ID and the value tag of the current version of the SIB of interest to UE 601A in operation 615 (denoted by the dotted arrow as an option). UE 601A may consider that the received SIB is valid.

In response to receiving the indicator or the current version of the SIB of interest, UE 601A may start a validity timer for the SIB of interest. The value of the timer may be, for example, configurable or predefined in 3GPP specifications. In an example, the value of the timer may be predefined as 3 hours. UE 601A may transmit a request for the SIB to a serving relay node (e.g., relay node 301B) in response to the expiry of the validity timer.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates an exemplary procedure 700 for wireless communications in accordance with some embodiments of the present disclosure. Details described in all of the foregoing embodiments of the present disclosure are applicable for the embodiments shown in FIG. 7.

Referring to FIG. 7, before switching to relay node 701B, UE 701A may access a cell (not shown in FIG. 7) via another relay node (source relay node, not shown in FIG. 7) and receive the SIB(s) from the source relay node, or UE 701A may access the cell via a Uu link. In some examples, relay node 701B may function as UE 101A or UE 101B shown in FIG. 1, or UE 301B shown in FIG. 3. UE 701A may function as UE 101C shown in FIG. 1 or UE 301A shown in FIG. 3.

Due to some reasons, UE 701A may switch from the source relay node or the serving cell to relay node 701B. After switching to relay node 701B, UE 701A may need to determine the validity of the system information applied at UE 701A and updated the invalid system information accordingly.

In some embodiments of the present disclosure, in operation 711, relay node 701B may transmit information associated with the system information being, for example, broadcast in the serving cell of relay node 701B to UE 701A. For example, relay node 701B may transmit a system information area ID and a value tag of a specific SIB (e.g., a first SIB) to UE 701A.

In operation 713, UE 701A may determine whether to update the first SIB based on the received system information area ID and value tag. For example, if the received system information area ID and value tag are the same as those of the first SIB applied at UE 701A, UE 701A may consider that the applied first SIB is valid and there is no need to update the first SIB.

Otherwise, if either the system information area IDs or the value tags are different, UE 701A may determine to update the first SIB. For example, in operation 715 (denoted by the dotted arrow as an option), UE 701A may transmit a list of SIBs of interest including the first SIB to relay node 701B.

In operation 717 (denoted by the dotted arrow as an option), in response to receiving the list of SIBs of interest, relay node 701B may transmit the SIB(s) listed in the list, for example, an updated version of the first SIB, to UE 701A. Relay node 701B may also transmit the system information area ID and value tag of the updated version of the first SIB to UE 701A. The updated version of the first SIB is the one being, for example, broadcast in the serving cell of relay node 701B.

UE 701A may consider that the received SIB(s) is valid. For example, in response to receiving the updated version of the first SIB, UE 701A may start a validity timer for the first SIB. UE 701A may transmit a request for the first SIB to a serving relay node (e.g., relay node 701B) in response to the expiry of the validity timer.

It should be appreciated by persons skilled in the art that the sequence of the operations in exemplary procedure 700 may be changed and some of the operations in exemplary procedure 700 may be eliminated or modified, without departing from the spirit and scope of the disclosure.

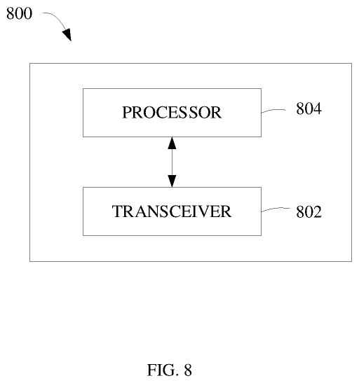

FIG. 8 illustrates a block diagram of an exemplary apparatus 800 according to some embodiments of the present disclosure.

As shown in FIG. 8, the apparatus 800 may include at least one processor 804 and at least one transceiver 802 coupled to the processor 804. The apparatus 800 may be a BS, a network node (e.g., a relay node) or a UE.

Although in this figure, elements such as the at least one transceiver 802 and processor 804 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a relay node. The transceiver 802 may be configured to: receive a request for a system information block (SIB) from a user equipment (UE), wherein the UE accesses a cell via the relay node; transmit the requested SIB to the UE; receive an updated version of the requested SIB from the cell; and transmit the updated version of the requested SIB to the UE. In some embodiments of the present disclosure, the transceiver 802 and the processor 804 may interact with each other so as to perform the operations with respect to the relay nodes described in FIGS. 1-7.

In some embodiments of the present application, the apparatus 800 may be a UE. The transceiver 802 may be configured to: transmit a request for a system information block (SIB) to a relay node, wherein the UE accesses a cell via the relay node; receive the requested SIB from the relay node; and receive an updated version of the requested SIB from the relay node. In some embodiments of the present disclosure, the transceiver 802 and the processor 804 may interact with each other so as to perform the operations with respect to the UEs described in FIGS. 1-7.

In some embodiments of the present application, the apparatus 800 may be a BS. The transceiver 802 and the processor 804 may interact with each other so as to perform the operations with respect to the BSs (e.g., cells) described in FIGS. 1-7.

In some embodiments of the present application, the apparatus 800 may further include at least one non-transitory computer-readable medium. In some embodiments of the present disclosure, the non-transitory computer-readable medium may have stored thereon computer-executable instructions to cause the processor 804 to implement the method with respect to the relay nodes as described above. For example, the computer-executable instructions, when executed, cause the processor 804 interacting with transceiver 802 to perform the operations with respect to the relay nodes described in FIGS. 1-7.

In some embodiments of the present application, the apparatus 800 may further include at least one non-transitory computer-readable medium. In some embodiments of the present disclosure, the non-transitory computer-readable medium may have stored thereon computer-executable instructions to cause the processor 804 to implement the method with respect to the UEs as described above. For example, the computer-executable instructions, when executed, cause the processor 804 interacting with transceiver 802 to perform the operations with respect to the UEs described in FIGS. 1-7.

In some embodiments of the present application, the apparatus 800 may further include at least one non-transitory computer-readable medium. In some embodiments of the present disclosure, the non-transitory computer-readable medium may have stored thereon computer-executable instructions to cause the processor 804 to implement the method with respect to the BSs (e.g., cells) as described above. For example, the computer-executable instructions, when executed, cause the processor 804 interacting with transceiver 802 to perform the operations with respect to the BSs (e.g., cells) described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A method performed by a relay node, comprising:
receiving a request for a system information block (SIB) from a user equipment (UE), wherein the UE accesses a cell via the relay node;
transmitting the requested SIB to the UE;
receiving an updated version of the requested SIB from the cell; and
transmitting the updated version of the requested SIB to the UE.

2. The method of claim 1, further comprising:
maintaining an association between the UE and a SIB list, wherein the SIB list contains the requested SIB.

3. The method of claim 2, further comprising:
receiving, from the UE, an indicator indicating that the requested SIB is not needed at the UE; and
removing the requested SIB from the SIB list in response to receiving the indicator.

4. The method of claim 2, further comprising:
in response to the SIB being updated by the cell, receiving the SIB based on the SIB list from the cell; and
wherein transmitting the updated version of the requested SIB to the UE comprises transmitting the updated version of the requested SIB based on the association.

5. The method of claim 1, further comprising:
transmitting a SIB list indicating that the requested SIB is updated to the UE in response to receiving the updated version of the requested SIB from the cell;
receiving an additional request for the updated version of the requested SIB from the UE; and
transmitting the updated version of the requested SIB to the UE.

6-8. (canceled)

9. The method of claim 1, further comprising at least one of:
storing the requested SIB at the relay node after transmitting the requested SIB to the UE;
receiving an acknowledgement of the requested SIB received from the UE, and discarding the requested SIB in response to receiving the acknowledgement and no additional request received for the requested SIB; or
receiving the acknowledgement of the requested SIB received from the UE, starting a timer in response to receiving the acknowledgement, and discarding the requested SIB in response to expiry of the timer.

10. (canceled)

11. The method of claim 1, wherein at least one of:
the request for the SIB is received via a radio resource control (RRC) reconfiguration sidelink message, which includes a SIB request list indicating the requested SIB; or
the request for the SIB is received via a PC5 RRC message specified for SIB request.

12. The method of claim 1, further comprising:
starting a timer in response to transmitting the requested SIB to the UE;
receiving an acknowledgement of the requested SIB received from the UE; and
stopping the timer in response to receiving the acknowledgement.

13-14. (canceled)

15. A relay node for wireless communication, comprising:
at least one memory; and
at least one processor coupled with the at least one memory and configured to cause the relay node to:
receive a request for a system information block (SIB) from a user equipment (UE), wherein the UE accesses a cell via the relay node;
transmit the requested SIB to the UE;
receive an updated version of the requested SIB from the cell; and
transmit the updated version of the requested SIB to the UE.

16. The relay node of claim 15, wherein the at least one processor is configured to cause the relay node to maintain an association between the UE and a SIB list, the SIB list containing the requested SIB.

17. The relay node of claim 16, wherein the at least one processor is configured to cause the relay node to:
receive, from the UE, an indication that the requested SIB is not needed at the UE; and
remove the requested SIB from the SIB list.

18. The relay node of claim 16, wherein the at least one processor is configured to cause the relay node to:
in response to the SIB being updated by the cell, receive the SIB based on the SIB list from the cell; and
transmit the updated version of the requested SIB to the UE based on the association.

19. The relay node of claim 15, wherein the at least one processor is configured to cause the relay node to:
transmit a SIB list indicating that the requested SIB is updated to the UE in response to the updated version of the requested SIB received from the cell;
receive an additional request for the updated version of the requested SIB from the UE; and
transmit the updated version of the requested SIB to the UE.

20. The relay node of claim 15, wherein the at least one processor is configured to cause the relay node to at least one of:
store the requested SIB at the relay node after the requested SIB is transmitted to the UE;
receive an acknowledgement of the requested SIB received from the UE, and discard the requested SIB in response to receiving the acknowledgement and no additional request received for the requested SIB; or
receive the acknowledgement of the requested SIB received from the UE, start a timer in response to receiving the acknowledgement, and discard the requested SIB in response to expiry of the timer.

21. The relay node of claim 15, wherein at least one of:
the request for the SIB is received via a radio resource control (RRC) reconfiguration sidelink message that includes a SIB request list indicating the requested SIB; or
the request for the SIB is received via a PC5 RRC message specified for SIB request.

22. The relay node of claim 15, wherein the at least one processor is configured to cause the relay node to:
start a timer in response to the requested SIB transmitted to the UE;
receive an acknowledgement of the requested SIB received from the UE; and
stop the timer in response to receiving the acknowledgement.

23. A user equipment (UE) for wireless communication, comprising:
at least one memory; and
at least one processor coupled with the at least one memory and configured to cause the UE to:
transmit a request for a system information block (SIB) to a relay node, the UE configured to access a cell via the relay node;
receive the requested SIB from the relay node; and
receive an updated version of the requested SIB from the relay node.

24. The UE of claim 23, wherein the at least one processor is configured to cause the UE to transmit, to the relay node, an indication that the requested SIB is not needed at the UE.

25. A processor for wireless communication, comprising:
at least one controller coupled with at least one memory and configured to cause the processor to:
transmit a request for a system information block (SIB) to a relay node, the processor of a user equipment (UE) configured to access a cell via the relay node;
receive the requested SIB from the relay node; and
receive an updated version of the requested SIB from the relay node.

26. The processor of claim 25, wherein the at least one controller is configured to cause the processor to transmit, to the relay node, an indication that the requested SIB is not needed at the UE.
